(19) United States
(12) Patent Application Publication
(10) Pub. No.: US 2026/0025491 A1
(43) Pub. Date: Jan. 22, 2026

(54) ELECTRONIC DEVICE, DISPLAY DEVICE AND THREE-DIMENSIONAL IMAGING METHOD THEREOF

(71) Applicant: Acer Incorporated, New Taipei City (TW)

(72) Inventors: Chieh-Sheng WANG, New Taipei City (TW); Chao-Kuang YANG, New Taipei City (TW); Wen-Cheng HSU, New Taipei City (TW); Pin-Cheng CHEN, New Taipei City (TW)

(73) Assignee: Acer Incorporated, New Taipei City (TW)

(21) Appl. No.: 18/913,523

(22) Filed: Oct. 11, 2024

(30) Foreign Application Priority Data
Jul. 19, 2024 (TW) 113127176

(51) Int. Cl. H04N 13/156; H04N 13/302; H04N 13/383

(52) U.S. Cl. CPC H04N 13/156; H04N 13/302; H04N 13/383

(57) ABSTRACT

An electronic device, a display device and a three-dimensional imaging method thereof are provided. The electronic device includes a display unit, an input unit, an artificial intelligence frame-filling model, a detection unit and an imaging unit. The input unit is used to obtain a first original image and a second original image. The first original image is captured at a first angle, and the second original image is captured at a second angle. The artificial intelligence frame-filling model is used to generate a plurality of intermediate generated images between the first original image and the second original image. The detection unit is used to detect a viewing angle of a user relative to the display unit. The imaging unit is used to present one of the first original image, the intermediate generated images and the second original image on the display unit according to the viewing angle.

This application claims the benefit of Taiwan application Serial No. 113127176, filed Jul. 19, 2024, the disclosure of which is incorporated by reference herein in its entirety.

### TECHNICAL FIELD

The disclosure relates in general to an electronic device and a controlling method thereof, and more particularly to an electronic device, a display device and a three-dimensional imaging method thereof.

### BACKGROUND

Today's 3D photography cameras have gradually matured, but in order to view the photos taken by the 3D camera, the user must purchase additional related equipment, such as a naked-eye 3D screen or 3D glasses.

In order to make 3D images more popular, the industry is working hard to develop stereoscopic display technology that could be applied to general displays.

### SUMMARY

The disclosure is directed to an electronic device, a display device and a three-dimensional imaging method thereof. An artificial intelligence frame-filling technology is used to generate a plurality of generated images corresponding to a plurality of viewing angles, and the image is presented on the display unit according to the viewing angle of the user, making the user feel that he is watching around a three-dimensional foreground object.

According to one embodiment, a three-dimensional imaging method is provided. The three-dimensional imaging method includes the following steps. A first original image and a second original image are obtained. The first original image is captured at a first angle, and the second original image is captured at a second angle which is different from the first angle. A plurality of intermediate generated images are generated via an artificial intelligence frame-filling model. A viewing angle of a user relative to the display unit is detected. One of the first original image, the intermediate generated images and the second original image is presented on the display unit according to the viewing angle.

According to another embodiment, an electronic device is provided. The electronic device includes a display unit, an input unit, an artificial intelligence frame-filling model, a detection unit and an imaging unit. The input unit is configured to obtain a first original image and a second original image. The first original image is captured at a first angle, and the second original image is captured at a second angle which is different from the first angle. The artificial intelligence frame-filling model is configured to generate a plurality of intermediate generated images. The detection unit is configured to detect a viewing angle of a user relative to the display unit. The imaging unit is configured to present one of the first original image, the intermediate generated images and the second original image on the display unit according to the viewing angle.

According to an alternative embodiment, a display device is provided. The display device includes a display unit, an input unit, an artificial intelligence frame-filling model and an imaging unit. The input unit is configured to obtain a first original image and a second original image. The first original image is captured at a first angle, and the second original image is captured at a second angle which is different from the first angle. The artificial intelligence frame-filling model is configured to generate a plurality of intermediate generated images. The imaging unit is configured to present the first original image, the intermediate generated images and the second original image in turn on the display unit.

### BRIEF DESCRIPTION OF THE DRAWINGS

FIGS. 1A to 1B illustrate a three-dimensional imaging method according to an embodiment of the present disclosure.

FIG. 2 shows the relationship between the foreground object and the user.

FIG. 3 illustrates a block diagram of an electronic device according to an embodiment.

FIG. 4 illustrates a flow chart of a three-dimensional imaging method according to an embodiment.

FIG. 5 illustrates the step S120.

FIGS. 6 to 7 illustrate the step S130.

FIG. 8 illustrates steps S150 to S160.

FIG. 9 illustrates a block diagram of a display device according to another embodiment of the present disclosure.

FIG. 10 illustrates a flow chart of a three-dimensional imaging method according to an embodiment.

FIG. 11 illustrates the step S260.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

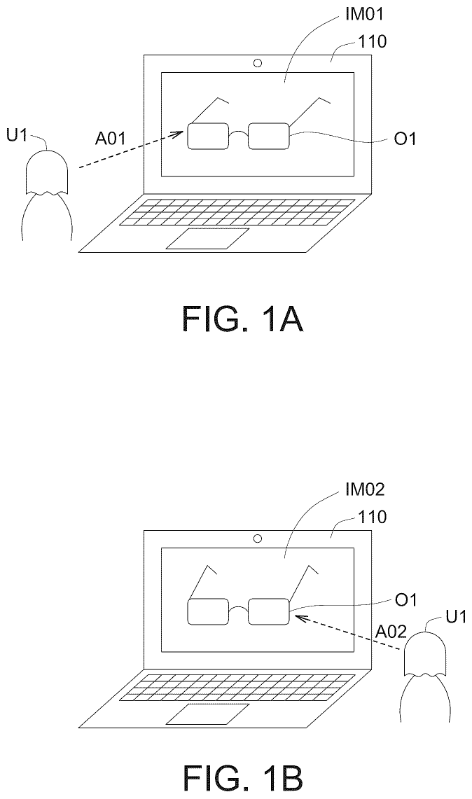

Please refer to FIGS. 1A to 1B, which illustrate a three-dimensional imaging method according to an embodiment of the present disclosure. As shown in the FIG. 1A, the user U1 looks at a display unit 110 at a viewing angle A01, and the display unit 110 displays an image IM01 of a foreground object O1 corresponding to the viewing angle A01. As shown in the FIG. 1B, the user U1 looks at the display unit 110 at a viewing angle A02, and the display unit 110 displays an image IM02 of the foreground object O1 corresponding to the viewing angle A02.

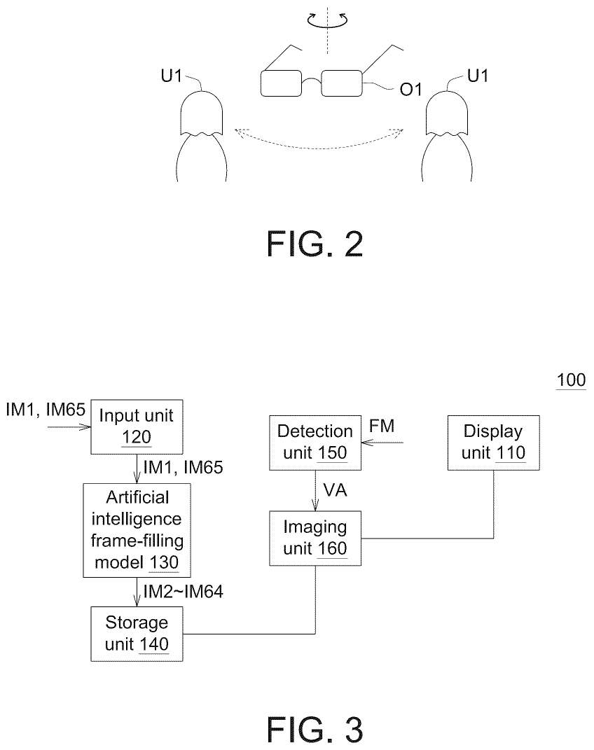

Please refer to FIG. 2, which shows the relationship between the foreground object O1 and the user U1. Once the user U1 changes the viewing angle, the display unit 110 will display images of the foreground object O1 with different angles accordingly. It is as if the user U1 is watching around the three-dimensional foreground object O1.

Please refer to FIG. 3, which illustrates a block diagram of an electronic device 100 according to an embodiment. The electronic device 100 includes a display unit 110, an input unit 120, an artificial intelligence frame-filling model 130, a storage unit 140, a detection unit 150 and an imaging unit 160. The display unit 110 is used to display a picture, such as a liquid crystal display panel, an OLED display panel or an electronic paper display panel.

The input unit 120 is used to receive data, such as a transmission port, a wireless transmission module or a wired network transmission module.

The artificial intelligence frame-filling model 130 is used to generate images, such as a SpatialParallax-AI system, which could be realized by a circuit, a circuit board, a storage device that stores program code, or a chip.

The detection unit 150 is used for tracking and detecting faces, such as a convolutional neural network (CNN), a long short-term memory network (LSTM), a recurrent neural network (RNN), a generative adversarial network (GAN), or a Radial Basis Function Network (RBFN), which could be realized by a circuit, a circuit board, a storage device storing program code, or a chip.

The imaging unit 160 is used to present the generated image on the display unit 110, which could be realized by a circuit, a circuit board, a storage device that stores program code, or a chip.

The chip is, for example, a circuit, a circuit board, a storage device storing program codes or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

The storage unit 140 is, for example, any type of fixed or movable random access memory (RAM), read-only memory (ROM), flash memory, hard disk drive (HDD), solid state drive (SSD), similar components, or a combination of the above components, used to store various applications that can be executed by the processor.

In this embodiment, the artificial intelligence frame-filling technology is used to generate the generated images corresponding to different viewing angles, and the image is presented on the display unit 110 according to the viewing angle of the user U1, so that user U1 feels that he is surrounding the three-dimensional foreground object O1. The following is accompanied by a flow chart to explain in detail the operation of each component.

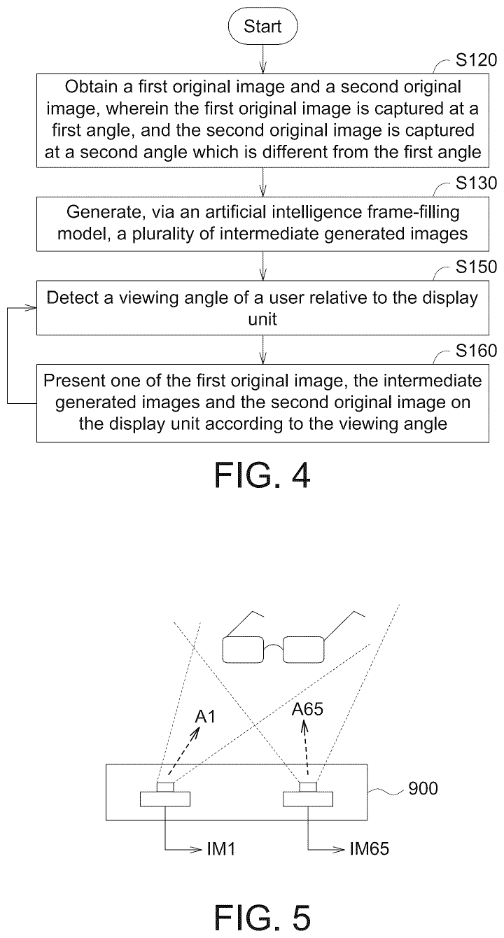

Please refer to FIG. 4, which illustrates a flow chart of a three-dimensional imaging method according to an embodiment. The three-dimensional imaging method includes steps S120, S130, S150 and S160.

Please refer to FIG. 5, which illustrates the step S120. In the step S120, the input unit 120 obtains a first original image IM1 and a second original image IM65. The first original image IM1 is captured at a first angle A1, and the second original image IM65 is captured at a second angle A65. The first angle A1 is different from the second angle A65. The first original image IM1 and the second original image IM65 are, for example, a left eye image and a right eye image captured by a 3D camera 900.

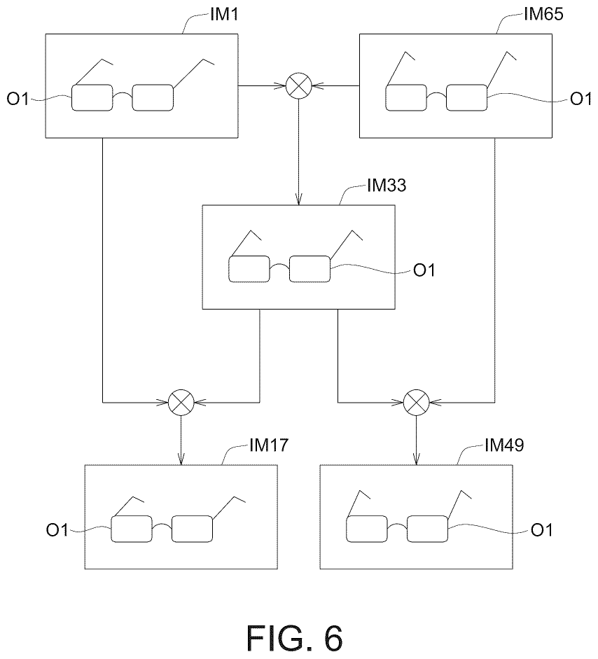

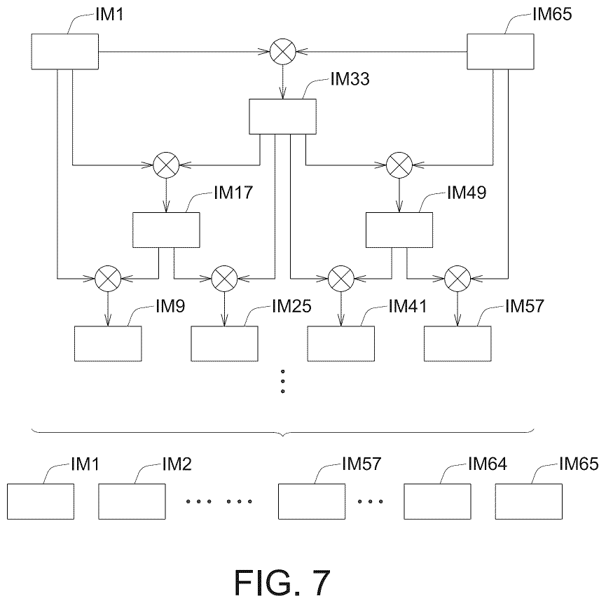

Next, please refer to FIGS. 6 to 7, which illustrate the step S130. In the step S130, the artificial intelligence frame-filling model 130 generates the intermediate generated images IM2 to IM64. The artificial intelligence frame-filling model 130 generates one output image based on two input images at one time. As shown in the FIG. 6, the artificial intelligence frame-filling model 130 obtains the intermediate generated image IM33 according to the first original image IM1 and the second original image IM65. The artificial intelligence frame-filling model 130 then obtains the intermediate generated image IM17 according to the first original image IM1 and the intermediate generated image IM33. The artificial intelligence frame-filling model 130 then obtains the intermediate generated image IM49 according to the intermediate generated image IM33 and the second original image IM65.

As shown in the FIG. 7, the artificial intelligence frame-filling model 130 obtains the intermediate generated image IM9 according to the first original image IM1 and the intermediate generated image IM17. The artificial intelligence frame-filling model 130 then obtains the intermediate generated image IM25 according to the intermediate generated image IM17 and the intermediate generated image IM33. The artificial intelligence frame-filling model 130 then obtains the intermediate generated image IM41 according to the intermediate generated image IM33 and the intermediate generated image IM46. The artificial intelligence frame-filling model 130 then obtains the intermediate generated image IM57 according to the intermediate generated image IM49 and the second original image IM65. By analogy, the artificial intelligence frame-filling model 130 is repeatedly executed to obtain the intermediate generated images IM2 to IM64.

In the step S130, the artificial intelligence frame-filling model 130 first crops out the foreground object O1, and then generates various images with different view angles according to the foreground object O1, instead of interpolating the entire image. In this disclosure, only the foreground object O1 in each of the images with different view angles is generated, so that the foreground object O1 in the images is rotated relative to the background.

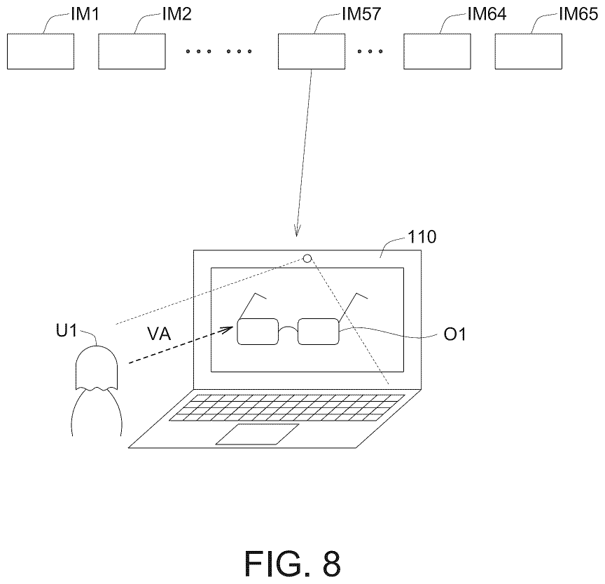

Then, please refer to FIG. 8, which illustrates steps S150 to S160. In the step S150, the detection unit 150 detects the viewing angle VA of the user U1 relative to the display unit 110. In this step, the detection unit 150 tracks a face in a shooting frame FM (shown in FIG. 3) in front of the display unit 110 to obtain the viewing angle VA. The shooting frame FM in front of the display unit 110 has a fixed imaging range, so the viewing angle VA could be determined based on the position of the face.

Then, in the step S160, the imaging unit 160 presents one of the first original image IM1, the intermediate generated images IM2 to IM64 and the second original image IM65 on the display unit 110 according to the viewing angle VA. The imaging unit 160 selects only one of the images to present on the display unit 110. Once the user U1 moves the position and changes the viewing angle VA, the imaging unit 160 will replace another image corresponding to the new viewing angle VA. It seems as if the user U1 is watching around the three-dimensional foreground object O1.

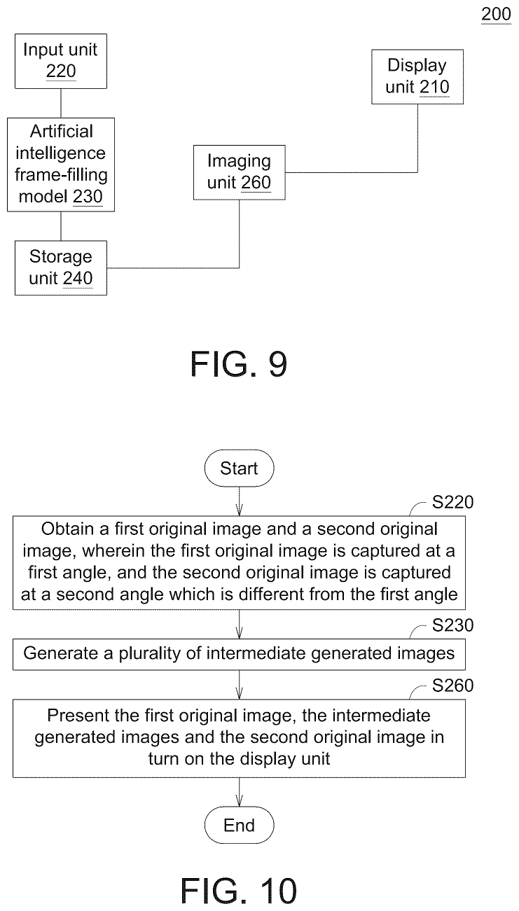

Please refer to FIG. 9, which illustrates a block diagram of a display device 200 according to another embodiment of the present disclosure. The display device 200 includes a display unit 210, an input unit 220, an artificial intelligence frame-filling model 230, a storage unit 240 and an imaging unit 260. The display unit 210 is used to display a picture, such as a liquid crystal display panel, an OLED display panel or an electronic paper display panel. The input unit 220 is used to receive data, such as a transmission port, a wireless transmission module or a wired network transmission module. The artificial intelligence frame-filling model 230 is used to generate images, such as a SpatialParallax-AI system, which could be realized by a circuit, a circuit board, a storage device that stores program code, or a chip. The imaging unit 260 is used to present the generated image on the display unit 110, which could be realized by a circuit, a circuit board, a storage device that stores program code, or a chip. The storage unit 140 is, for example, any type of fixed or removable memory or hard disk.

In this embodiment, the artificial intelligence frame-filling technology is used to generate a plurality of generated images corresponding to different viewing angles, and the images corresponding different view angles are automatically played in a loop, making the user U1 feel that the three-dimensional foreground object O1 is being rotated. The following is accompanied by a flow chart to explain in detail the operation of each component.

Please refer to FIG. 10, which illustrates a flow chart of a three-dimensional imaging method according to an embodiment. The three-dimensional imaging method includes steps S220, S230 and S260.

Please refer to FIG. 5, which illustrates step S220. In the step S220, the input unit 220 obtains the first original image IM1 and the second original image IM65. The first original image IM1 is captured at the first angle A1, and the second original image IM65 is captured at the second angle A65. The first angle A1 is different from the second angle A65. This step is similar to the above step S120, and the similarities will not be repeated.

Next, please refer to FIGS. 6 to 7, which illustrate the step S230. In the step S230, the artificial intelligence frame-filling model 230 generates the intermediate generated images IM2 to IM64. This step is similar to the above step S130, and the similarities will not be repeated.

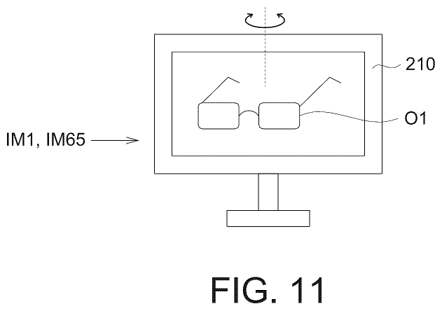

Then, please refer to FIG. 11, which illustrates the step S260. In the step S260, the imaging unit 260 presents the first original image IM1, the intermediate generated image IM2 to IM64 and the second original image IM65 in turn on the display unit 210. For example, the imaging unit 260 sequentially presents the first original image IM1, the intermediate generated images IM2 to IM64 and the second original image IM65, and then presents the second original image IM65, the intermediate generated images IM64 to IM2 and the first original image IM1 in reverse order. The foreground object O1 presented by the display unit 210 will be rotated and swung left and right.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed. It will be apparent to those skilled in the art that various modifications and variations can be made to the disclosed embodiments. It is intended that the specification and examples be considered as exemplars only, with a true scope of the disclosure being indicated by the following claims and their equivalents.

1. A three-dimensional imaging method, comprising:
obtaining a first original image and a second original image, wherein the first original image is captured at a first angle, and the second original image is captured at a second angle which is different from the first angle;
generating, via an artificial intelligence frame-filling model, a plurality of intermediate generated images;
detecting a viewing angle of a user relative to the display unit; and
presenting one of the first original image, the intermediate generated images and the second original image on the display unit according to the viewing angle, wherein the first original image, the intermediate generated images and the second original image show identical object and identical view.

2. The three-dimensional imaging method according to claim 1, wherein in the step of obtaining the first original image and the second original image, the first original image and the second original image are a left eye image and a right eye image taken by a 3D camera.

3. The three-dimensional imaging method according to claim 1, wherein in the step of generating the intermediate generated images, the artificial intelligence frame-filling model generates one output image based on two input images.

4. The three-dimensional imaging method according to claim 3, wherein in the step of generating the intermediate generated images, the artificial intelligence frame-filling model is repeatedly executed to obtain the intermediate generated images.

5. The three-dimensional imaging method according to claim 1, wherein in the step of generating the intermediate generated images, the artificial intelligence frame-filling model is executed according to a foreground object.

6. The three-dimensional imaging method according to claim 1, wherein in the step of detecting the viewing angle of the user relative to the display unit, a face is tracked on a shooting frame in front of the display unit to obtain the viewing angle.

7. The three-dimensional imaging method according to claim 1, wherein the step of detecting the viewing angle of the user relative to the display unit is executed after the step of generating the intermediate generated images.

8. An electronic device, comprising:
a display unit;
an input unit, configured to obtain a first original image and a second original image, wherein the first original image is captured at a first angle, and the second original image is captured at a second angle which is different from the first angle;
an artificial intelligence frame-filling model, configured to generate a plurality of intermediate generated images;
a detection unit, configured to detect a viewing angle of a user relative to the display unit; and
an imaging unit, configured to present one of the first original image, the intermediate generated images and the second original image on the display unit according to the viewing angle, wherein the first original image, the intermediate generated images and the second original image show identical object and identical view.

9. The electronic device according to claim 8, wherein the first original image and the second original image are a left eye image and a right eye image taken by a 3D camera.

10. The electronic device according to claim 8, wherein the artificial intelligence frame-filling model generates one output image based on two input images.

11. The electronic device according to claim 10, wherein the artificial intelligence frame-filling model is repeatedly executed to obtain the intermediate generated images.

12. The electronic device according to claim 8, wherein the artificial intelligence frame-filling model is executed according to a foreground object.

13. The electronic device according to claim 8, wherein the detection unit tracks a face on a shooting frame in front of the display unit to obtain the viewing angle.

14. A display device, comprising:
a display unit;
an input unit, configured to obtain a first original image and a second original image, wherein the first original image is captured at a first angle, and the second original image is captured at a second angle which is different from the first angle;
an artificial intelligence frame-filling model, configured to generate a plurality of intermediate generated images; and
an imaging unit, configured to present the first original image, the intermediate generated images and the second original image in turn on the display unit, wherein the first original image, the intermediate generated images and the second original image show identical object and identical view.

15. The display device according to claim 14, wherein the first original image and the second original image are a left eye image and a right eye image taken by a 3D camera.

16. The display device according to claim 14, wherein the artificial intelligence frame-filling model generates one output image based on two input images.

17. The display device according to claim 14, wherein the artificial intelligence frame-filling model is repeatedly executed to obtain the intermediate generated images.

18. The display device according to claim 14, wherein the artificial intelligence frame-filling model is executed according to a foreground object.

19. The display device according to claim 14, wherein the artificial intelligence frame-filling model crops out a foreground object, and then generates the intermediate generated images according to the foreground object.

20. The display device according to claim 14, wherein the imaging unit sequentially presents the first original image, the intermediate generated images and the second original image, and then presents the second original image, the intermediate generated images, and the first original image in reverse order.
